(19) United States
(12) Patent Application Publication
(10) Pub. No.: US 2025/0193596 A1
(43) Pub. Date: Jun. 12, 2025

(54) ACOUSTIC SYSTEM

(71) Applicant: SHENZHEN SHOKZ CO., LTD., Shenzhen (CN)

(72) Inventors: Bocheng LI, Shenzhen (CN); Chenyang WU, Shenzhen (CN)

(73) Assignee: SHENZHEN SHOKZ CO., LTD., Shenzhen (CN)

(21) Appl. No.: 19/055,460

(22) Filed: Feb. 17, 2025

Related U.S. Application Data
(63) Continuation of application No. PCT/CN2023/096286, filed on May 25, 2023.

(51) Int. Cl. H04R 3/04; H04R 1/02; H04R 1/40; H04R 3/00; H04R 29/00

(52) U.S. Cl. CPC H04R 3/04; H04R 1/025; H04R 1/406; H04R 3/005; H04R 29/001; H04R 2430/01

(57) ABSTRACT

An acoustic system is provided, including: a speaker, a first sound sensor, a second sound sensor, and a signal processing circuit. When operating, the first sound sensor collects ambient sound and generates a first signal, the ambient sound includes a first sound from the speaker and a second sound from a target sound source. When operating, the second sound sensor collects ambient sound and generates a second signal, the first signal and the second signal satisfy k₂≥2k₁, where k₁ is a ratio of the signal energy corresponding to the first sound to the signal energy corresponding to the second sound in the first signal, and k₂ is a ratio of the signal energy corresponding to the first sound to the signal energy corresponding to the second sound in the second signal.

### RELATED APPLICATIONS

This disclosure is a continuation application of PCT application No. PCT/CN2023/096286, filed on May 25, 2023, and the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of acoustic technology, and in particular to an acoustic system.

### BACKGROUND

Some acoustic systems include both a speaker and a sound sensor. There is usually a problem of acoustic feedback in these acoustic systems. Specifically, acoustic feedback refers to the situation where the sound signal collected by the sound sensor is processed and then played through the speaker, and the sound emitted by the speaker is again collected by the sound sensor, thus forming a closed-loop circuit of “speaker->sound sensor->speaker” in the acoustic system. In the above acoustic systems, the sound from the speaker picked up by the sound sensor can be referred to as feedback sound. The presence of feedback sound leads to some problems in the acoustic system. For example, it can cause howling and other issues in the acoustic system and may also limit the maximum forward gain that the acoustic system can achieve. Therefore, it is necessary to provide an acoustic system that can reduce or eliminate feedback sound.

### SUMMARY

This disclosure provides an acoustic system that can reduce or eliminate feedback sound, thereby avoiding issues such as howling caused by feedback sound and improving the maximum forward gain that the acoustic system can achieve.

This disclosure provides an acoustic system, including: a speaker, configured to receive a drive signal and convert the drive signal into a first sound when operating; a first sound sensor, configured to collect ambient sound and generate a first signal when operating, wherein the ambient sound comprises the first sound and a second sound from a target sound source, the target sound source comprises a sound source other than the speaker; a second sound sensor, configured to collect the ambient sound and generate a second signal when operating, wherein the first signal and the second signal satisfy k₂≥2k₁, wherein k₁ is a ratio of a signal energy corresponding to the first sound to a signal energy corresponding to the second sound in the first signal, and k₂ is a ratio of a signal energy corresponding to the first sound to a signal energy corresponding to the second sound in the second signal; and a signal processing circuit, connected to the first sound sensor and the second sound sensor, and configured to: reduce a signal components in the first signal corresponding to the first sound based on the second signal to obtain a target signal, and perform a target operation on the target signal.

According to the above technical solution, the acoustic system provided in this disclosure includes: a speaker, a first sound sensor, a second sound sensor, and a signal processing circuit. The speaker operates to receive a driving signal and convert it into a first sound; the first sound sensor operates to collect ambient sound and generate a first signal, where the ambient sound includes the first sound and a second sound from a target sound source; the second sound sensor operates to collect ambient sound and generate a second signal, where the first signal and the second signal satisfy k₂≥2k₁, where k₁ is the ratio of the signal energy corresponding to the first sound to the signal energy corresponding to the second sound in the first signal, and k₂ is the ratio of the signal energy corresponding to the first sound to the signal energy corresponding to the second sound in the second signal. The signal processing circuit is connected to the first sound sensor and the second sound sensor, and during operation, it reduces the signal components corresponding to the first sound in the first signal based on the second signal to obtain a target signal and performs a target operation on the target signal.

Therefore, the acoustic system provided in this disclosure can reduce or eliminate feedback components in the target signal, thereby avoiding issues such as howling caused by feedback sound and improving the maximum forward gain that the acoustic system can achieve.

Other functions of the acoustic system provided in this disclosure will be partially listed in the following description. The inventive aspects of the acoustic system provided in this disclosure can be fully explained through the practice or use of the methods, devices, and combinations described in the detailed examples below.

### BRIEF DESCRIPTION OF THE DRAWINGS

In order to more clearly illustrate the technical solutions in the embodiments of this disclosure, a brief introduction to the accompanying drawings required in the description of the embodiments is provided below. It is evident that the accompanying drawings described below are merely some exemplary embodiments of this disclosure. For a person skilled in the art, other drawings can also be obtained based on these drawings without creative effort.

FIG. 1 is a schematic diagram of an application scenario provided in some exemplary embodiments of this disclosure;

FIG. 2 is a schematic diagram of the design of an acoustic system provided in some exemplary embodiments of this disclosure;

FIG. 3 is a schematic diagram of the design of an acoustic system provided in some exemplary embodiments of this disclosure;

FIG. 4 is a schematic diagram of the design of an acoustic system provided in some exemplary embodiments of this disclosure;

FIG. 5 is a schematic diagram of the design of an acoustic system provided in some exemplary embodiments of this disclosure;

FIGS. 6A to 6F are certain schematic diagrams of the structure of an acoustic system provided in some exemplary embodiments of this disclosure;

FIGS. 7A to 7G are other schematic diagrams of the structure of an acoustic system provided in some exemplary embodiments of this disclosure;

FIGS. 8A to 8F are yet other schematic diagrams of the structure of an acoustic system provided in some exemplary embodiments of this disclosure;

FIG. 9 is a schematic diagram of the pickup directivity of an acoustic system provided in some exemplary embodiments of this disclosure;

FIG. 10A is a schematic diagram of the positions of a first sound sensor and a second sound sensor within a target area of an acoustic system provided in some exemplary embodiments of this disclosure;

FIG. 10B is a schematic diagram of the feedback sound energy corresponding to various positions within a target area of the acoustic system; and

FIG. 11 is a schematic diagram of test results for adaptive filtering performance of an acoustic system provided in some exemplary embodiments of this disclosure.

### DETAILED DESCRIPTION

The following description provides specific application scenarios and requirements of this disclosure, with the aim of enabling those skilled in the art to manufacture and use the content of this disclosure. For those skilled in the art, various local modifications to the disclosed embodiments are apparent, and the general principles defined here can be applied to other embodiments and applications without departing from the spirit and scope of this disclosure. Therefore, this disclosure is not limited to the embodiments shown but is intended to cover the broadest scope consistent with the claims.

The terms used herein are for the purpose of describing specific example embodiments and are not meant to be restrictive. For example, unless otherwise explicitly stated in the context, the singular forms “a,” “an,” and “the” may also include the plural forms. When used in this disclosure, the terms “include,” “comprise,” and/or “contain” mean that the associated integer, step, operation, element, and/or component is present but do not exclude the presence of one or more other features, integers, steps, operations, elements, components, and/or groups, or the possibility of adding other features, integers, steps, operations, elements, components, and/or groups to the system/method.

Given the following description, these features and other features of the disclosure, as well as the operation and functionality of the related elements of the structure, and the combination and manufacturability of the parts, can be significantly improved. The accompanying drawings, which form part of this disclosure, are referenced for illustration. However, it should be clearly understood that the drawings are for illustration and description purposes only and are not intended to limit the scope of this disclosure. It should also be understood that the drawings are not drawn to scale.

The flowcharts used in this disclosure illustrate the operations of the system implementation according to some exemplary embodiments of this disclosure. It should be clearly understood that the operations in the flowcharts may not be implemented in a specific order. Instead, the operations may be performed in reverse order or concurrently. Additionally, one or more other operations may be added to the flowcharts, or one or more operations may be removed from them.

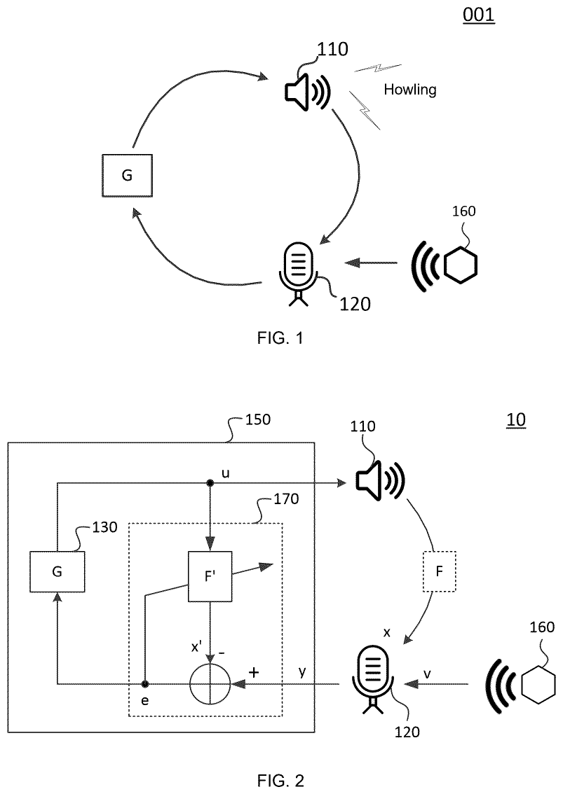

Before describing the specific embodiments of this disclosure, the application scenarios of this disclosure are introduced as follows. The acoustic system provided in this disclosure can be applied to scenarios where it is necessary to reduce or eliminate feedback sound. An example is provided below with reference to FIG. 1.

FIG. 1 shows a schematic diagram of an application scenario provided in some exemplary embodiments of this disclosure. As shown in FIG. 1, application scenario 001 can be a sound amplification scenario, an assistive listening scenario, a hearing aid scenario, etc. In this scenario, the sound sensor 120 operates to collect ambient sound. During this process, if the speaker 110 is also playing sound simultaneously, the sound played by the speaker 110 will also be collected by the sound sensor 120. As a result, the ambient sound collected by the sound sensor 120 includes both the sound from the target sound source 160 and the sound from the speaker 110. Furthermore, the pickup signal collected by the sound sensor 120 is amplified by forward gain (G) and then input to the speaker 110 to drive the speaker 110 to produce sound. This forms a closed-loop circuit of “speaker->sound sensor->speaker” in the acoustic system. In this case, when the sound signals of certain frequencies undergo self-excited oscillation, a howling phenomenon will occur. Such howling can cause discomfort to the user, and in severe cases, it may even damage components within the acoustic system. Additionally, the presence of howling also imposes limitations on the forward gain amplification factor of the acoustic system, thereby restricting the maximum forward gain that the acoustic system can achieve.

It should be noted that the application scenario shown in FIG. 1 is only one of the multiple applicable scenarios for this disclosure. The acoustic system provided in this disclosure can also be applied to other similar scenarios, which are not exhaustively listed in this disclosure. A person skilled in the art should understand that the application of the acoustic system provided in this disclosure to other usage scenarios also falls within the scope of protection of this disclosure.

In summary, the presence of feedback sound can cause a series of problems in the acoustic system, including but not limited to howling and limiting the maximum forward gain that the acoustic system can achieve. To address these issues, this disclosure provides an acoustic system capable of reducing or eliminating feedback sound, thereby avoiding the aforementioned problems.

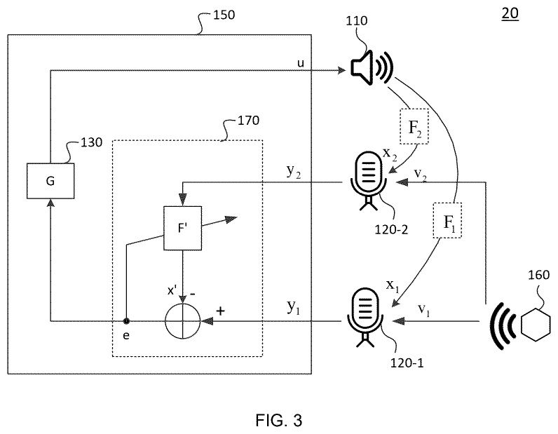

The acoustic system provided in this disclosure can adopt Acoustic Feedback Cancellation (AFC) technology to reduce or eliminate feedback sound. For the convenience of the following description, the principle of AFC technology will be introduced below with reference to FIG. 2.

FIG. 2 illustrates a schematic diagram of the design of an acoustic system provided in some exemplary embodiments of this disclosure. The acoustic system 10 can be a hearing/assistive listening system or a sound amplification system. The acoustic system 10 can utilize Acoustic Feedback Cancellation (AFC) technology to reduce or eliminate feedback component(s) (i.e., signal component(s) corresponding to feedback sound). As shown in FIG. 2, the acoustic system 10 may include a speaker 110, a sound sensor 120, and a signal processing circuit 150.

The speaker 110 is a device used to convert electrical signals into sound and can also be referred to as an electroacoustic transducer. For example, the speaker 110 may be a loudspeaker. The speaker 110 can produce sound based on at least one transmission medium, such as gas, liquid, or solid. The speaker 110 can be connected to the signal processing circuit 150 and operates by receiving electrical signals from the signal processing circuit 150 and converting them into sound for playback. In some exemplary embodiments, the acoustic system 10 may further include a first peripheral circuit (not shown in FIG. 2). The first peripheral circuit is connected between the signal processing circuit 150 and the speaker 110. It can include all or part of the circuitry between the output of the signal processing circuit 150 and the speaker 110. The first peripheral circuit can perform certain processing on the electrical signals output by the signal processing circuit 150 to make the processed signals suitable for playback by the speaker 110. The first peripheral circuit may include, but is not limited to, at least one of the following components: operational amplifiers, power amplifiers, digital-to-analog converters, capacitors, inductors, and resistors.

The sound sensor 120 is a device used to pick up sound and convert it into electrical signals, and can also be referred to as an electroacoustic transducer. For example, the sound sensor 120 may be a microphone (MIC). The sound sensor 120 can be a device that picks up sound based on at least one transmission medium, such as gas, liquid, or solid. The sound sensor 120 can be connected to the signal processing circuit 150 and operates by collecting ambient sound, converting it into electrical signals, and then transmitting these electrical signals to the signal processing circuit 150. In some exemplary embodiments, the acoustic system 10 may further include a second peripheral circuit (not shown in FIG. 2). The second peripheral circuit is connected between the sound sensor 120 and the signal processing circuit 150. It can include all or part of the circuitry between the sound sensor 120 and the input terminal of the signal processing circuit 150. The second peripheral circuit can perform certain processing on the electrical signals picked up by the sound sensor 120 to convert them into signals suitable for processing by the signal processing circuit 150. The second peripheral circuit may include, but is not limited to, at least one of the following components: power amplifiers, operational amplifiers, analog-to-digital converters, capacitors, inductors, and resistors.

Referring again to FIG. 2, the sound sensor 120 collects ambient sound to generate a pickup signal y and inputs the pickup signal y to the signal processing circuit 150. The ambient sound includes at least the second sound emitted by the target sound source 160. The target sound source 160 refers to sound sources other than the speaker 110. For example, the target sound source 160 may include electronic devices with sound playback functions (such as televisions, speakers, mobile phones, etc.). Additionally, the target sound source 160 may also include a human throat. The pickup signal y can be referred to as the input signal of the signal processing circuit 150. The signal processing circuit 150 performs a series of processing operations on the pickup signal y to obtain a driving signal u, which is then sent to the speaker 110. The driving signal u can be regarded as the output signal of the signal processing circuit 150. The speaker 110 receives the driving signal u and converts it into the first sound. After being transmitted through the feedback path, the first sound is recollected by the sound sensor 120. Therefore, the first sound can also be referred to as the feedback sound. As a result, the ambient sound collected by the sound sensor 120 includes not only the second sound from the target sound source 160 but also the first sound from the speaker 110. In other words, the pickup signal y includes both the signal component x corresponding to the first sound (i.e., feedback sound) and the signal component v corresponding to the second sound.

The signal processing circuit 150 can be a circuit with certain signal processing capabilities. The input end of the signal processing circuit 150 is connected to the sound sensor 120, and the output end is connected to the speaker 110. During operation, it can receive the pickup signal y from the sound sensor 120, perform a preset signal processing procedure on the pickup signal y to obtain the driving signal u, and then transmit the driving signal u to the speaker 110.

In some exemplary embodiments, the signal processing circuit 150 may include multiple hardware circuits that are connected. Each hardware circuit comprises one or more electrical components, with each electrical component implementing one or more functional units. These multiple hardware circuits work together to implement the signal processing procedure.

In some exemplary embodiments, the signal processing circuit 150 may include hardware devices with data information processing capabilities and the necessary programs required to drive the hardware devices. The hardware devices perform the signal processing procedure by executing the programs. For example, the signal processing circuit 150 may include at least one storage medium and at least one processor. The storage medium may include data storage devices, which can be non-transitory storage media or transitory storage media. For instance, the data storage device may include one or more of magnetic disks, read-only memory (ROM), or random-access memory (RAM). The storage medium also includes at least one instruction set stored in the data storage device. The instructions are computer program codes, which may include programs, routines, objects, components, data structures, processes, modules, and so on for executing the signal processing method provided in this disclosure.

The at least one processor can be in communication with the at least one storage medium. The at least one processor is used to execute the aforementioned at least one instruction set. When the acoustic system is in operation, the at least one processor reads the at least one instruction set and, according to the instructions of the instruction set, performs the signal processing procedure. The processor may include one or more hardware processors, such as microcontrollers, microprocessors, Reduced Instruction Set Computers (RISC), Application-Specific Integrated Circuits (ASIC), Application-Specific Instruction-set Processors (ASIP), Central Processing Units (CPU), Graphics Processing Units (GPU), Physics Processing Units (PPU), microcontroller units, Digital Signal Processors (DSP), Field-Programmable Gate Arrays (FPGA), Advanced RISC Machines (ARM), Programmable Logic Devices (PLD), or any circuits or processors capable of performing one or more functions, or any combination thereof.

Continuing with FIG. 2, in order to reduce or eliminate feedback components, the signal processing circuit 150 may include an Acoustic Feedback Cancellation (AFC) unit 170. The inputs of the AFC unit 170 include the driving signal u and the pickup signal y. The AFC unit 170 can reduce the signal components in the pickup signal y that correspond to the first sound based on the driving signal u, thereby obtaining the target signal e.

In conjunction with FIG. 2, the internal structure of the acoustic feedback cancellation unit 170 can solve for and adaptively update a time-varying transfer function F′ to approximate the transfer function F corresponding to the feedback path. For distinction, the transfer function F′ will be referred to as the predicted transfer function F′, and the transfer function F corresponding to the feedback path will be referred to as the actual transfer function F. The acoustic feedback cancellation unit 170 performs an adaptive filtering operation on the drive signal u using the predicted transfer function F′ to obtain the signal x′, i.e., x′=u*F′. The signal x′ can be regarded as the predicted value of the feedback component in the pickup signal y (i.e., the signal component in the pickup signal y corresponding to the first sound). Furthermore, the acoustic feedback cancellation unit 170 can subtract the signal x′ from the pickup signal y to obtain the target signal e, i.e., e=y−x′. The resulting target signal e contains no or fewer components of the feedback sound.

It should be noted that various adaptive filtering algorithms can be used to solve for the predicted transfer function F′ in the aforementioned acoustic feedback cancellation unit 170. For example, the Least Mean Square (LMS), Normalized Least Mean Square (NLMS), Recursive Least Squares (RLS), other adaptive filtering algorithms, or any derivative algorithms of the aforementioned algorithms can be employed, either individually or in combination. This disclosure does not impose any limitations in this regard. In addition, the adaptive filtering algorithm can perform adaptive filtering in the time domain, frequency domain, or other transform domains.

According to the theory of adaptive filtering algorithms, the update of the predicted transfer function F′ can be achieved by minimizing the expectation of the mean square function of the target signal e, i.e.:

$${min}_{{F}^{′}} E [ {e}^{2} ] = {min}_{{F}^{′}} E [ {( y - u * {F}^{′} )}^{2} ] \qquad Formula ( 1 - 1 )$$

For example, when the acoustic feedback cancellation unit 170 adopts the LMS algorithm, the optimization method based on gradient descent can be used to derive the above formula (1-1), resulting in the following update formula for the predicted transfer function F′:

$${F}^{′} ← {F}^{′} + μ * e * u \qquad Formula ( 2 - 1 )$$

Where μ is the iteration step size.

It should be understood that when the acoustic feedback cancellation unit 170 adopts algorithms such as NLMS, RLS, etc., similar methods can be used to derive the update formula for the predicted transfer function F′. This disclosure will not provide examples for each case.

It can be seen that the acoustic system shown in FIG. 2, by adopting AFC technology, can reduce or eliminate feedback sounds, thereby avoiding a series of problems caused by feedback sounds.

According to signal processing theory, the closed-loop gain A of the acoustic system shown in FIG. 2 can be expressed as follows:

$$A = \frac{u}{v} = \frac{G}{1 - G ( F - {F}^{′} )} \qquad Formula ( 3 - 1 )$$

According to the Nyquist stability criterion, the requirement for the acoustic system to cancel the feedback sound is that the solved predicted transfer function F′ must be exactly equal to the actual transfer function F, i.e., F′=F. When this requirement is met, the acoustic system will always be stable and will not produce feedback howl. Additionally, the acoustic system can achieve infinite gain, i.e., when the forward gain G→∞, A=G→∞.

However, in a practical acoustic system, since the actual transfer function F may be time-varying and the iterative solution process may oscillate, it is difficult for the iteration of F′ to reach the ideal condition F′=F. In other words, there is a certain deviation between the predicted transfer function F′ obtained from the actual iteration and the actual transfer function F. In this case, in order to keep the acoustic system stable, the forward gain G provided by the gain amplifier unit 130 cannot naturally approach infinity. The maximum forward gain that the acoustic system can achieve is:

$${G}_{max} = \frac{1}{\vert F - {F}^{′} \vert} \qquad Formula ( 4 )$$

As seen in formula (4), the deviation between the predicted transfer function F′ and the actual transfer function F can be used to measure the convergence performance of the adaptive filtering algorithm, and in turn, the effectiveness of the acoustic system in canceling feedback sound. Specifically, if the deviation between the predicted transfer function F′ and the actual transfer function F is smaller, it indicates better convergence performance of the adaptive filtering algorithm, and thus the acoustic system performs better in canceling feedback sound. Conversely, if the deviation is larger, it indicates poorer convergence performance of the adaptive filtering algorithm, and the acoustic system will perform worse in canceling feedback sound.

In some exemplary embodiments, we can also use the misalignment (MIS) to measure the convergence performance of the adaptive filtering algorithm. The misalignment MIS can be expressed by the following formula:

$$MIS = 20 {log}_{10} \frac{\vert {F}^{′} - F \vert}{\vert F \vert} \qquad Formula ( 5 )$$

The misalignment (MIS) is measured in decibels (dB). When the predicted transfer function F′ is initialized to zero, the misalignment MIS is 0 dB. As the misalignment MIS decreases and approaches negative infinity, the deviation between the predicted transfer function F′ and the actual transfer function F becomes smaller, indicating better convergence performance of the adaptive filtering algorithm, and thus better feedback sound cancellation by the acoustic system. Conversely, as the misalignment MIS increases and approaches positive infinity, the deviation between the predicted transfer function F′ and the actual transfer function F becomes larger, indicating poorer convergence performance of the adaptive filtering algorithm, and consequently worse feedback sound cancellation by the acoustic system.

It should be noted that the convergence performance of the adaptive filtering algorithm in this disclosure includes, but is not limited to, factors such as convergence speed and convergence error. Specifically, the convergence speed refers to the rate at which the predicted transfer function F′ fits the actual transfer function F, while the convergence error refers to the deviation between the predicted transfer function F′ and the actual transfer function F when the convergence condition is met.

In the acoustic system shown in FIG. 2, the reason it is possible to solve for a time-varying predicted transfer function F′ through an adaptive filtering algorithm to fit the transfer function F corresponding to the feedback path is based on the following ideal assumption: the feedback path is entirely linear in its transfer.

However, in practice, the acoustic system typically does not meet this ideal assumption. This is because, in the real acoustic system, there are various devices in the feedback path, and these devices may exhibit nonlinear responses. For example, the interaction between the diaphragm and the magnet of the speaker 110 can lead to hysteresis effects and saturation distortion, meaning that the response of the speaker 110 contains nonlinear components. Additionally, there are often power amplifiers, operational amplifiers, and other devices between the signal processing circuit 150 and the speaker 110. Power amplifiers and operational amplifiers typically exhibit clipping effects, so their responses also contain nonlinear components. Similarly, other devices present between the signal processing circuit 150 and the speaker 110 may also contribute nonlinear responses.

Since the acoustic feedback cancellation unit 170 obtains the drive signal u before the output port of the signal processing circuit 150 and performs adaptive filtering on the drive signal u using the predicted transfer function F′, the nonlinear responses of devices such as the speaker 110, power amplifier, and operational amplifier inevitably get introduced into the iterative solution of the predicted transfer function F′. As a result, this leads to lower convergence performance of the adaptive filtering algorithm, for example, causing the predicted transfer function F′ to fail to converge, converge slowly, or have large convergence errors. This worsens the misalignment (MIS) metric of the acoustic system, which in turn affects the acoustic system's effectiveness in canceling feedback sound.

Additionally, in some acoustic system design architectures, the acoustic feedback cancellation unit 170 may be independent of other units in the signal processing circuit 150, and the system architecture may limit access or communication between different units. As a result, the acoustic feedback cancellation unit 170 may not be able to obtain the drive signal u from other units. Consequently, such an acoustic system would not be able to use AFC technology to reduce or eliminate feedback sound.

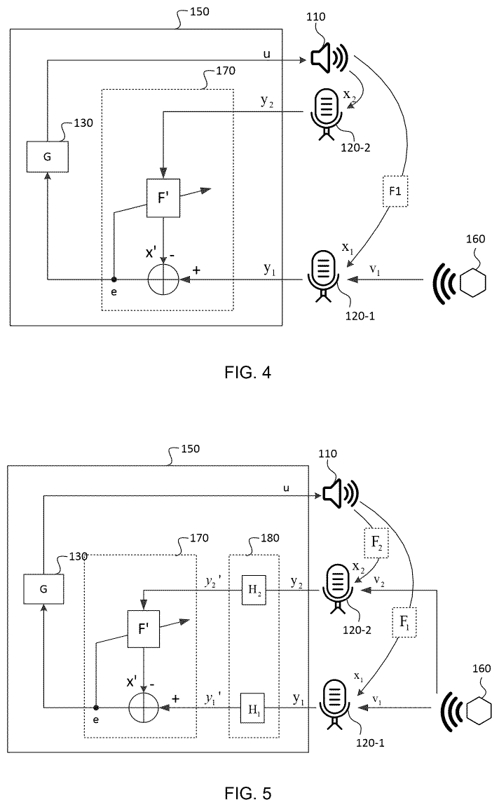

FIG. 3 shows a design schematic of the acoustic system provided in some exemplary embodiments of this disclosure. As shown in FIG. 3, the acoustic system 20 may include: speaker 110, first sound sensor 120-1, second sound sensor 120-2, and signal processing circuit 150.

The acoustic system 20 shown in FIG. 3 can be considered as an enhancement to the acoustic system 10 shown in FIG. 2. By comparing FIG. 2 and FIG. 3, it can be seen that the first sound sensor 120-1 in the acoustic system 20 of FIG. 3 corresponds to the sound sensor 120 in the acoustic system 10 of FIG. 2. Thus, the acoustic system 20 in FIG. 3 can be viewed as an extension of the acoustic system 10 in FIG. 2, with the addition of the second sound sensor 120-2. The structure of the second sound sensor 120-2 can be the same as or different from that of the first sound sensor 120-1, and this disclosure does not impose any limitations on this.

The working process of the acoustic system 20 shown in FIG. 3 is as follows: When the speaker 110 operates, it receives the drive signal u from the signal processing circuit 150 and converts the drive signal u into the first sound. The first sound sensor 120-1 operates by capturing ambient sound and generating the first signal y1. The second sound sensor 120-2 operates by capturing ambient sound and generating the second signal y2. The ambient sound includes both the first sound from the speaker 110 and the second sound from the external sound source 160. Therefore, the first signal y1 includes components corresponding to the first sound, denoted as x1, and components corresponding to the second sound, denoted as v1. Similarly, the second signal y2 includes components corresponding to the first sound, denoted as x2, and components corresponding to the second sound, denoted as v2. The external sound source 160 includes other sound sources in the environment besides the speaker 110, such as a person's throat, electronic devices with sound playback functions, other speakers, etc.

It should be noted that the first sound emitted by the speaker 110 can be transmitted through one or more media, such as gas, liquid, or solid, and then picked up by the first sound sensor 120-1 and the second sound sensor 120-2. Similarly, the second sound emitted by the target sound source 160 can be transmitted through one or more media (gas, liquid, or solid) and then picked up by the first and second sound sensors. Additionally, this disclosure does not limit the medium used to carry the first signal y1, second signal y2, and drive signal u. All three signals can be carried by any suitable carrier. For example, the first signal y1, second signal y2, and drive signal u can be electrical signals, optical signals, digital carrier signals, or other types of signals.

In the acoustic system 20 shown in FIG. 3, the first and second sound sensors 120-1 and 120-2 have different focus areas when picking up sounds. The first sound sensor 120-1 primarily picks up sounds from the target sound source 160, while the second sound sensor 120-2 mainly picks up sounds from the speaker 110. Specifically, the first signal y1 picked up by the first sound sensor 120-1 and the second signal y2 picked up by the second sound sensor 120-2 satisfy the following relationship:

$${k}_{2} \geq 2 {k}_{1} \qquad Formula ( 6 )$$

Where k1 is the ratio of the signal energy |x1|2 corresponding to the first sound in the first signal y1 to the signal energy |v1|2 corresponding to the second sound, and k2 is the ratio of the signal energy |x2|2 corresponding to the first sound in the second signal y2 to the signal energy |v2|2 corresponding to the second sound, i.e.:

$${k}_{1} = \frac{{\vert {x}_{1} \vert}^{2}}{{\vert {v}_{1} \vert}^{2}} \qquad Formula ( 7 )$$

$${k}_{2} = \frac{{\vert {x}_{2} \vert}^{2}}{{\vert {v}_{2} \vert}^{2}} \qquad Formula ( 8 )$$

In other words, the ratio of k2 to k1 is recorded as N, that is: N=k2/k1, then the value of N can be a real number greater than or equal to 2. For example, the value of N can be within the interval specified by any two of 2, 3, 4, 5, 6, 7, 8, 9, 10, 11, 12, 13, 14, 15, 16, 17, 18, 19, 20, . . . ∞. When the value of N is larger and closer to ∞, the second sound sensor 120-2 is closer to picking up only the sound of the speaker 110, and the first sound sensor 120-1 is closer to picking up only the sound of the target sound source 160. In addition, when the ratio between k2 to k1 is N, the closed-loop gain A of the acoustic system can be expressed as follows:

$$A = G * ( 1 - \frac{1}{\sqrt{N}} ) \qquad Formula ( 20 )$$

It should be noted that the derivation method of the above formula (20) can be referred to the derivation process of formula (19) later, which will not be described in detail herein. It can be seen from the above formula (20) that when the value of N gradually increases, the closed-loop gain A and the forward gain G gradually approach each other, that is, the energy loss of the system gradually decreases.

When the value of N is ∞, the closed-loop gain A reaches the ideal forward gain G.

In order to satisfy the above condition k2≥2k2, the first signal y1 and the second signal y2 can satisfy one or more of the following conditions:

(1) The ratio of the signal energy |x2|2 corresponding to the first sound in the second signal y2 to the signal energy |v2|2 corresponding to the second sound in the second signal y2 is greater than or equal to 2, that is:

$$\frac{{\vert {x}_{2} \vert}^{2}}{{\vert {v}_{2} \vert}^{2}} \geq 2 \qquad Formula ( 9 )$$

The above condition can also be expressed as: the signal energy |x2|2 corresponding to the first sound in the second signal y2 is much greater than the signal energy |v2|2 corresponding to the second sound in the second signal y2. It can be understood that when |x2|2 is much greater than |v2|2, k2 can be made as large as possible, so that the second sound sensor 120-2 picks up the first sound much more than the second sound. When k2 approaches infinity, the second sound sensor 120-2 almost only picks up the first sound, and does not pick up the second sound.

(2) The ratio of the signal energy |v1|2 corresponding to the second sound in the first signal y1 to the signal energy |x1|2 corresponding to the first sound in the first signal y1 is greater than or equal to 2, that is:

$$\frac{{\vert {v}_{1} \vert}^{2}}{{\vert {x}_{1} \vert}^{2}} \geq 2 \qquad Formula ( 10 )$$

The above condition can also be expressed as: the signal energy |v1|2 corresponding to the second sound in the first signal y1 is much greater than the signal energy |x1|2 corresponding to the first sound in the first signal y1. It can be understood that when |v1|2 is much greater than |x1|2, k1 can be made as small as possible, so that the first sound sensor 120-1 picks up the second sound much more than the first sound.

When k1 approaches zero, the first sound sensor 120-2 almost only picks up the second sound, and does not pick up the first sound.

(3) The ratio of the signal energy |x2|2 corresponding to the first sound in the second signal y2 to the signal energy |x1|2 corresponding to the first sound in the first signal y1 is greater than or equal to 2, that is:

$$\frac{{\vert {x}_{2} \vert}^{2}}{{\vert {x}_{1} \vert}^{2}} \geq 2 \qquad Formula ( 11 )$$

The above condition can also be expressed as: the signal energy |x2|2 corresponding to the first sound in the second signal y2 is much greater than the signal energy |x1|2 corresponding to the first sound in the first signal y1. It can be understood that when |x2|2 is much greater than |x1|2, the second sound sensor 120-2 picks up the first sound much more than the first sound sensor 120-1 picks up the first sound,

For example, the second sound sensor 120-2 picks up almost all of the first sound, while the first sound sensor 120-2 picks up almost none of the first sound.

The signal processing circuit 150 can be connected to the first sound sensor 120-1 and the second sound sensor 120-2, respectively. The signal processing circuit 150 can obtain the first signal y1 from the first sound sensor 120-1 and the second signal y2 from the second sound sensor 120-2. Furthermore, the signal processing circuit 150 can reduce the signal component corresponding to the first sound in the first signal y1 based on the second signal y2, thereby obtaining the target signal e. In this way, the target signal e does not contain or contains less feedback sound component(s).

Similar to FIG. 2, the acoustic system shown in FIG. 3 can also reduce or eliminate the feedback component in the target signal based on the AFC technology. Continuing to refer to FIG. 3, the signal processing circuit 150 may include an acoustic feedback cancellation unit 170, and the acoustic feedback cancellation unit 170 can solve and adaptively update a time-varying predicted transfer function F′ to fit the actual transfer function F corresponding to the feedback path. The input of the acoustic feedback cancellation unit 170 includes: a first signal y1 and a second signal y2. The acoustic feedback cancellation unit 170 can reduce the signal component corresponding to the first sound in the first signal y1 based on the second signal y2, thereby obtaining the target signal e. Specifically, the acoustic feedback cancellation unit 170 uses the prediction transfer function F′ to perform an adaptive filtering operation on the second signal y2 to obtain the third signal x′, that is, x′=y2*F′. The third signal x′ can be regarded as the predicted value of the feedback component in the first signal y1 (that is, the signal component corresponding to the first sound in the first signal y1).

Furthermore, the acoustic feedback cancellation unit 170 can subtract the third signal x′ from the first signal y1 to obtain the target signal e, that is, e=y₁−x′=y₁−y₂*F′. The target signal e obtained in this way does not contain or contains less feedback sound component(s)

After obtaining the target signal e, the signal processing circuit 150 can also update the filtering parameters of the adaptive filtering operation F′ based on at least one of the second signal y2 and the target signal e. Specifically, according to the theory of the adaptive filtering algorithm, the update method of the predicted transfer function F′ can be achieved by minimizing the expectation of the mean square function of the target signal e, that is:

$${min}_{F ′} E [ {e}^{2} ] = {min}_{F ′} E [ {( {y}_{1} - {y}_{2} * {F}^{′} )}^{2} ] \qquad Formula ( 1 - 2 )$$

Still taking the acoustic feedback cancellation unit 170 using the LMS algorithm as an example, the above formula (1-2) is derived based on the optimization method of gradient descent, and the update formula of the predicted transfer function F′ can be obtained as follows:

$${F}^{′} ← {F}^{′} + μ * e * {y}_{2} \qquad Formula ( 2 - 2 )$$

Where, μ is the iteration step size.

It should be understood that when the acoustic feedback cancellation unit 170 adopts algorithms such as NLMS and RLS, the update formula of the predicted transfer function F′ can be derived in a similar manner, and this disclosure does not provide examples one by one.

As shown in FIG. 3, after obtaining the target signal e, the signal processing circuit 150 can perform target operations on the target signal e.

Continuing to refer to FIG. 3, the signal processing circuit 150 may further include a gain amplification unit 130 (the gain amplification unit is labeled as G in FIG. 3). The gain amplification unit performs gain amplification on the target signal e and sends the gain-amplified signal as the driving signal u at the next moment to the speaker 110, thereby driving the speaker 110 to produce sound. Since the feedback components in the target signal e are reduced or eliminated, it is possible to avoid or suppress howling in the acoustic system 10, and furthermore, it helps to improve the maximum forward gain that the acoustic system 10 can achieve.

As shown in FIG. 3, the acoustic system 20 picks up the first sound with a focus through the newly added second sound sensor 120-2 to obtain the second signal y2. Subsequently, the signal processing circuit 150 can use AFC technology to reduce the feedback components in the first signal y1 based on the second signal y2, thereby reducing or eliminating the feedback components. Compared to the acoustic system 10 shown in FIG. 2, the acoustic system 20 shown in FIG. 3 obtains the second signal y2 from the signal path behind the speaker 110. Therefore, when solving the predictive transfer function F′, the feedback cancellation unit 170 only needs to fit the transfer function of the feedback path after the speaker 110. This avoids the influence of the nonlinear responses of the speaker 110 and the devices before the speaker 110 (such as operational amplifiers, power amplifiers, etc.) on the convergence performance of the adaptive filtering algorithm, thereby improving the feedback sound cancellation effect. In addition, since the second signal y2 required by the feedback cancellation unit 170 is picked up through the second sound sensor 120-2, the application of AFC technology in the acoustic system 20 is not affected even if the interaction permissions between the feedback cancellation unit 170 and other units are limited. This reduces the design architecture requirements of the acoustic system for AFC technology and enhances the application flexibility and versatility of AFC technology.

In addition, since the feedback cancellation unit 170 originally has system access permissions to the first sound sensor 120-1, and the permissions required to access the second sound sensor 120-2 are of the same type as those required to access the first sound sensor 120-1, the acoustic system shown in FIG. 3 does not need to add new system access permissions to enable the feedback cancellation unit 170 to access data from the second sound sensor 120-2 after adding the second sound sensor 120-2.

Furthermore, after adding the second sound sensor 120-2, the acoustic system shown in FIG. 3 does not require changes to the internal implementation of the feedback cancellation unit 170. Specifically, it is not necessary to modify the update formula of the predictive transfer function For the calculation formula for feedback sound cancellation. Only the input signal u of the feedback cancellation unit 170 needs to be replaced with y2. This demonstrates that the acoustic system shown in FIG. 3 can apply, adapt to, and be compatible with existing feedback cancellation units 170, regardless of the type of adaptive filtering algorithm these existing feedback cancellation units 170 use (including but not limited to the previously mentioned LMS, NLMS, RLS, or other adaptive filtering algorithms). Therefore, the modification difficulty of the acoustic system is relatively low, with broad applicability.

The following section will verify the system stability of the acoustic system 20 shown in FIG. 3.

According to signal processing theory, the closed-loop gain A of the acoustic system shown in FIG. 3 can be expressed as follows:

$$A = \frac{u}{{v}_{1}} = \frac{G * ( 1 - \frac{{v}_{2}}{{v}_{1}} * {F}^{′} )}{1 - G * {F}_{1} * ( 1 - \frac{{F}_{2}}{{F}_{1}} * {F}^{′} )} \qquad Formula ( 3 - 2 )$$

Where F1 represents the acoustic transfer function from the speaker 110 to the first sound sensor 120-1, and F2 represents the acoustic transfer function from the speaker 110 to the second sound sensor 120-2.

According to the Nyquist stability criterion, the requirement for the acoustic system 20 to effectively cancel feedback sound is that the solved predictive transfer function F′ satisfies the following condition:

$$1 - \frac{{F}_{2}}{{F}_{1}} * {F}^{′} = 0 \qquad Formula ( 13 )$$

That is, the prediction transfer function F′ needs to satisfy:

$${F}^{′} = \frac{{F}_{1}}{{F}_{2}} \qquad Formula ( 14 )$$

When the predicted transfer function F′ satisfies the above formula (14), formula (3-2) can be transformed into:

$$A = G * ( 1 - \frac{{v}_{2} {F}_{1}}{{v}_{1} {F}_{2}} ) \qquad Formula ( 15 )$$

Since the first signal y1 and the second signal y2 satisfy the following condition: k2≥2k1, that is:

$$\frac{{\vert {x}_{2} \vert}^{2}}{{\vert {v}_{2} \vert}^{2}} \geq 2 * \frac{{\vert {x}_{1} \vert}^{2}}{{\vert {v}_{1} \vert}^{2}} \qquad Formula ( 16 )$$

By substituting x1 and x2 in formula (16), it can be obtained:

$$\frac{{\vert u * {F}_{2} \vert}^{2}}{{\vert {v}_{2} \vert}^{2}} \geq 2 * \frac{{\vert u * {F}_{1} \vert}^{2}}{{\vert {v}_{1} \vert}^{2}} \qquad Formula ( 17 )$$

By simplifying formula (17) yields:

$${\vert {v}_{1} {F}_{2} \vert}^{2} \geq 2 \cdot {\vert {v}_{2} {F}_{1} \vert}^{2} \qquad Formula ( 18 )$$

By substituting the above formula (18) into formula (15), it can be obtained:

$$A = G ( 1 - \frac{{v}_{2} {F}_{1}}{{v}_{1} {F}_{2}} ) \geq G ( 1 - \frac{1}{\sqrt{2}} ) \qquad Formula ( 19 )$$

It can be seen from formula (19) that when the forward gain G→∞, the closed-loop gain A→∞. Therefore, the acoustic system shown in FIG. 3 is still stable when the predicted transfer function F′ reaches the convergence condition. This confirms the correctness of the solution of this disclosure.

Based on the acoustic system 20 shown in FIG. 3, in some cases, when the second sound sensor 120-2 is in a strong feedback environment, the acoustic transfer function F2˜1 from the speaker 110 to the second sound sensor 120-2, and the first signal y1 and the second signal y2 satisfy the following conditions:

The signal energy |x2|2 corresponding to the first sound in the second signal y2 is much greater than the signal energy |v2|2 corresponding to the second sound in the second signal y2, that is, |x2|2>>|v2|2.

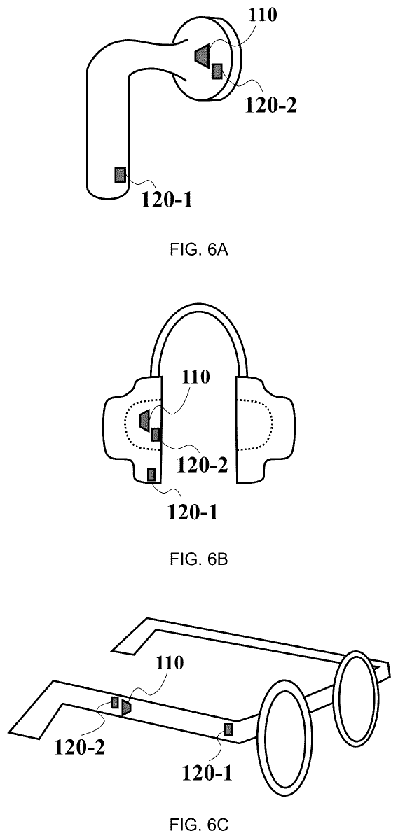

In this case, the acoustic system shown in FIG. 3 can be simplified to the acoustic system shown in FIG. 4. In the acoustic system shown in FIG. 4, the second sound sensor 120-2 almost only picks up the sound from the speaker 110. In this case, the second signal y2˜u. Therefore, the update formula of the predicted transfer function F′ can be updated as:

$${F}^{′} ← {F}^{′} + μ {ey}_{2} \approx {F}^{′} + μ eu \qquad Formula ( 2 - 3 )$$

Accordingly, the closed-loop gain A of the acoustic system 30 can be expressed as:

$$A = \frac{u}{{v}_{1}} = G \qquad Formula ( 3 - 3 )$$

It can be seen that when the second sound sensor 120-2 is located in a strong feedback scenario, the AFC mathematical expression in the acoustic system shown in FIG. 4 is exactly the same as the AFC mathematical expression based on ideal assumptions in the acoustic system shown in FIG. 2. This further confirms the correctness of the solution proposed in this disclosure.

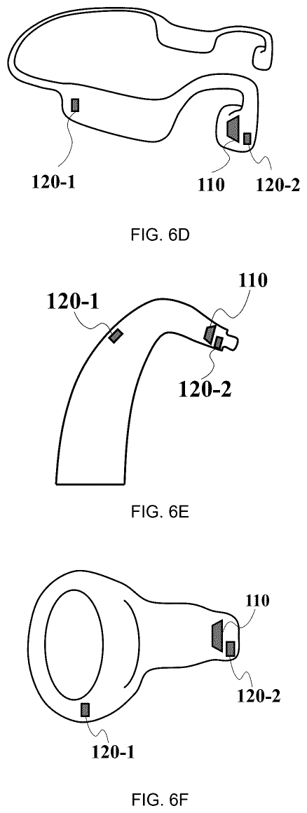

FIG. 5 is a design schematic of the acoustic system provided according to some exemplary embodiments of this disclosure. As shown in FIG. 5, the signal processing circuit 150 may also include a preprocessing unit 180. After receiving the first signal y1 and the second signal y2, the signal processing circuit 150 can preprocess the first signal y1 and the second signal y2 through the preprocessing unit 180. Specifically, the signal processing circuit 150 executes a first preprocessing operation H1 on the first signal y1 to obtain the first intermediate signal y1′, and executes a second preprocessing operation H2 on the second signal y2 to obtain the second intermediate signal y2′. Then, the first intermediate signal y1′ and the second intermediate signal y2′ are input into the acoustic feedback cancellation unit 170. The acoustic feedback cancellation unit 170 reduces the signal components corresponding to the first sound in the first intermediate signal y1′ based on the second intermediate signal y2′, resulting in the target signal e. It should be understood that the internal processing of the acoustic feedback cancellation unit 170 has been described earlier, so it will not be reiterated herein.

The first preprocessing operation H1 may include, but is not limited to, at least one of a gain amplification operation, a filtering operation, a frequency response compensation operation, or a phase modification operation. Similarly, the second preprocessing operation H2 may include, but is not limited to, at least one of a gain amplification operation, a filtering operation, a frequency response compensation operation, or a phase modification operation. When designing the acoustic system, the first preprocessing operation H1 and the second preprocessing operation H2 can be tailored to the requirements of different application scenarios. For example, in some cases, there may be a frequency response difference between the first sound sensor 120-1 and the second sound sensor 120-2. In such situations, appropriate first preprocessing operation H1 and second preprocessing operation H2 can be designed to compensate for the difference, thereby ensuring that the frequency responses of the first signal y1 and the second signal y2 match and satisfy the computational requirements of the AFC algorithm. Thus, by performing preprocessing operations on the first signal y1 and the second signal y2, the signal processing circuit 150 is able to meet the processing requirements of different application scenarios.

The above FIG. 3 to FIG. 5 are examples where the acoustic system 20 includes a single speaker 110. In some scenarios, the number of speakers 110 in the acoustic system 20 may be M, where M is an integer greater than 1. In this case, the number of second sound sensors 120-2 may also be M. The M second sound sensors 120-2 correspond one-to-one with the M speakers 110. The i-th second sound sensor 120-2 focuses on picking up the sound emitted by the i-th speaker 110.

Specifically, for any i-th second sound sensor in the M second sound sensors 120-2, the i-th second sound sensor 120-2 works by collecting ambient sound and generating the second signal y2i. The first signal y1 and the second signal y2i satisfy the condition k2≥2k1, where k2i is the ratio of the signal energy in the second signal y2i corresponding to the sound emitted by the i-th speaker 110 to the signal energy corresponding to the sound emitted by the target sound source. The target sound source includes other sound sources in the environment besides the i-th speaker. Furthermore, the signal processing circuit 150 can reduce the feedback components in the first signal y1 based on the second signal y2i, resulting in the target signal ei. The signal processing circuit then synthesizes the target signals e1 to eM to obtain the final target signal e, and performs the target operation on the target signal e.

It can be seen that when the acoustic system 20 includes M speakers 110, the acoustic system 20 may also include M second sound sensors 120-2. The i-th sound sensor 120-2 focuses on picking up the sound of the i-th speaker and is used in the adaptive filtering process of AFC. This effectively adds M AFC-based adaptive filtering processes to the acoustic system 20. Each adaptive filtering process is consistent with the description in FIG. 3 to FIG. 5, and will not be reiterated herein.

In summary, based on the acoustic system shown in FIG. 3 to FIG. 5, when the first signal y1 and the second signal y2 satisfy the condition k2≥2k1, the use of AFC technology can effectively reduce or eliminate feedback sound, and also avoid or minimize the impact of nonlinear responses on the convergence performance of the adaptive filtering algorithm.

The following explains in detail how the design of the acoustic system can be adjusted to ensure that the first signal y1 and the second signal y2 satisfy the condition k2≥2k1. It should be noted that there can be multiple design options for the acoustic system, and below are just a few possible examples. The different schemes listed below can be combined with each other.

Scheme 1: The acoustic system can be designed from a structural perspective, such that the positional relationship between the first sound sensor 120-1, the second sound sensor 120-2, and the speaker 110 satisfies predefined conditions, ensuring that the first signal y1 and the second signal y2 meet the condition k2≥2k1.

In some exemplary embodiments, the first sound sensor 120-1, the second sound sensor 120-2, and the speaker 110 meet predefined distance conditions.

For example, the distance condition may include the requirement that the distance between the second sound sensor 120-2 and the speaker 110 is much smaller than the distance between the first sound sensor 120-1 and the speaker 110. In other words, the second sound sensor 120-2 is placed as close as possible to the speaker 110 compared to the first sound sensor 120-1. Let the distance between the first sound sensor 120-1 and the speaker 110 be denoted as L1, and the distance between the second sound sensor 120-2 and the speaker 110 be denoted as L2. The distance condition is then expressed as: L1≥2L2. This distance condition can also be written as the ratio of L1 to L2 being greater than or equal to a preset value. The preset value can be any value from the intervals such as 2, 3, 4, 5, 6, 7, 8, 9, 10 . . . ∞.

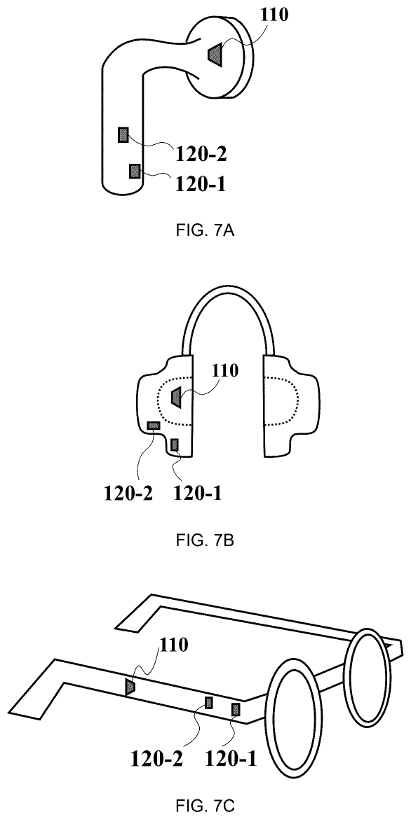

Next, with reference to FIG. 6A to FIG. 6F, some possible structures for the acoustic system will be illustrated. It should be noted that this disclosure does not limit the form of the acoustic system 20. For example, the acoustic system 20 can take the form of true wireless earbuds, over-ear headphones, glasses, behind-the-ear style, in-ear style, or any other possible form. FIG. 6A to FIG. 6F provide just a few examples of possible product forms.

For example, when the acoustic system 20 takes the form of true wireless earbuds, the positional relationship between the first sound sensor 120-1, the second sound sensor 120-2, and the speaker 110 can be as shown in FIG. 6A. When the acoustic system 20 takes the form of over-ear headphones, the positional relationship between the first sound sensor 120-1, the second sound sensor 120-2, and the speaker 110 can be as shown in FIG. 6B. When the acoustic system 20 takes the form of glasses, the positional relationship between the first sound sensor 120-1, the second sound sensor 120-2, and the speaker 110 can be as shown in FIG. 6C. When the acoustic system 20 takes the form of behind-the-neck style, the positional relationship between the first sound sensor 120-1, the second sound sensor 120-2, and the speaker 110 can be as shown in FIG. 6D. When the acoustic system 20 takes the form of behind-the-ear style, the positional relationship between the first sound sensor 120-1, the second sound sensor 120-2, and the speaker 110 can be as shown in FIG. 6E. The behind-the-ear style includes, but is not limited to, BTE (Behind-The-Ear), RIC (Receiver-In-Canal) in hearing aids. When the acoustic system 20 takes the form of in-ear style, the positional relationship between the first sound sensor 120-1, the second sound sensor 120-2, and the speaker 110 can be as shown in FIG. 6F. The in-ear style includes, but is not limited to, ITE (In-The-Ear), ITC (In-The-Canal), CIC (Completely-In-the-Canal) in hearing aids. The structures of the acoustic system shown in FIG. 6A to FIG. 6F all satisfy the distance condition L1≥2L2.

It should be understood that when the acoustic system satisfies the distance condition L1≥2L2, the second sound sensor 120-2 can pick up a stronger first sound than the first sound sensor 120-1. Therefore, the signal energy |x2|2 corresponding to the first sound in the second signal y2 is much greater than the signal energy |x1|2 corresponding to the first sound in the first signal y1, thereby helping the first signal y1 and the second signal y2 to satisfy the condition k2≥2k1.

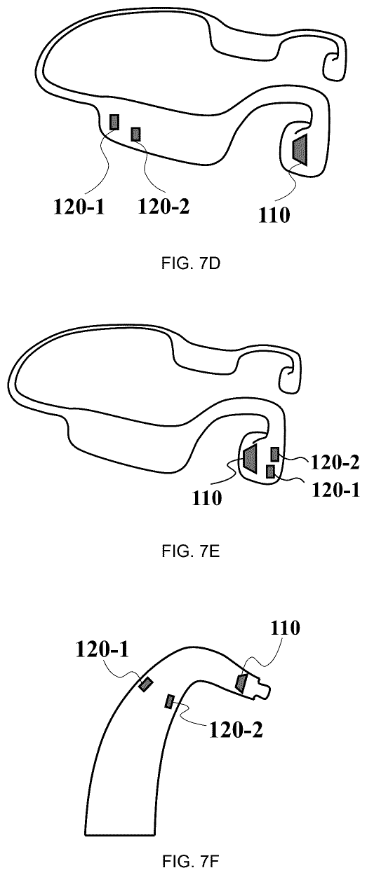

It is understandable that although FIG. 6A to FIG. 6F show examples of acoustic systems that meet the distance condition L1≥2L2, in some cases, certain acoustic systems may not meet this condition due to product form or specific requirements. In other words, the values of L1 and L2 may be quite close. For example, FIG. 7A to FIG. 7G show schematic diagrams of the acoustic system structure when the values of L1 and L2 are relatively close. Specifically, when the acoustic system 20 takes the form of true wireless earbuds, the positional relationship between the first sound sensor 120-1, the second sound sensor 120-2, and the speaker 110 can be as shown in FIG. 7A. When the acoustic system 20 takes the form of over-ear headphones, the positional relationship between the first sound sensor 120-1, the second sound sensor 120-2, and the speaker 110 can be as shown in FIG. 7B. When the acoustic system 20 takes the form of glasses, the positional relationship between the first sound sensor 120-1, the second sound sensor 120-2, and the speaker 110 can be as shown in FIG. 7C. When the acoustic system 20 takes the form of behind-the-neck style, the positional relationship between the first sound sensor 120-1, the second sound sensor 120-2, and the speaker 110 can be as shown in FIG. 7D (where both sound sensors are farther from the speaker) or as shown in FIG. 7E (where both sound sensors are closer to the speaker). When the acoustic system 20 takes the form of behind-the-ear style, the positional relationship between the first sound sensor 120-1, the second sound sensor 120-2, and the speaker 110 can be as shown in FIG. 7F. The behind-the-ear style includes, but is not limited to, BTE (Behind-The-Ear), RIC (Receiver-In-Canal) in hearing aids. When the acoustic system 20 takes the form of in-ear style, the positional relationship between the first sound sensor 120-1, the second sound sensor 120-2, and the speaker 110 can be as shown in FIG. 7G. The in-ear style includes, but is not limited to, ITE (In-The-Ear), ITC (In-The-Canal), CIC (Completely-In-the-Canal) in hearing aids.

In cases where the acoustic system cannot satisfy the distance condition L1≥2L2 (such as the situations shown in FIG. 7A to FIG. 7G), subsequent design approaches can be employed to ensure that the first signal y1 and the second signal y2 meet the condition k2≥2k1. It should be noted that when the acoustic system adopts the design approach shown in FIG. 6A to FIG. 6F, it can also be combined with one or more of the subsequent approaches.

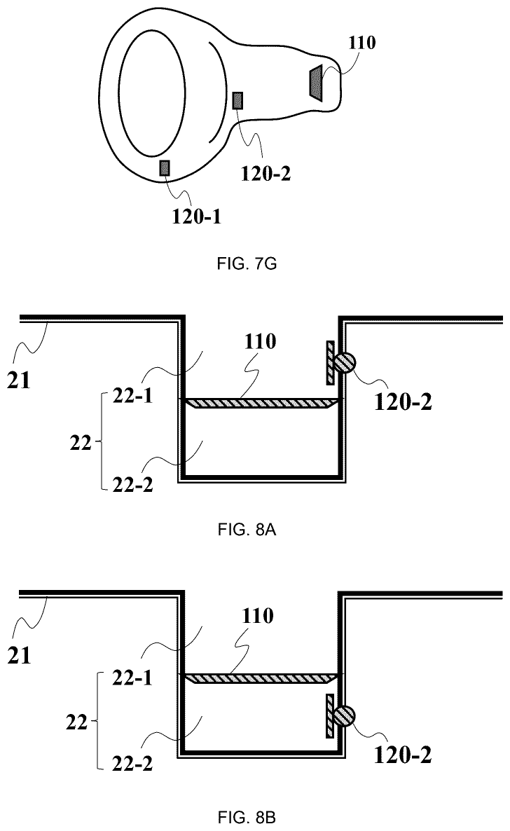

In some exemplary embodiments, the positional relationship between the first sound sensor 120-1, the second sound sensor 120-2, and the speaker 110 can meet predefined structural conditions. The structural conditions of the acoustic system are explained below with reference to FIG. 8A to FIG. 8F. It should be noted that FIG. 8A to FIG. 8F only show the partial structure of the acoustic system.

For example, the acoustic system 20 may adopt the design of an acoustic cavity. Referring to FIG. 8A to FIG. 8C, the acoustic system 20 can include a housing 21, with part of the housing 21 forming an acoustic cavity 22. It should be noted that the specific form of the acoustic cavity 22 is not limited by this disclosure. The speaker 110 is located inside the acoustic cavity 22. The sound generating component of the speaker 110 can divide the acoustic cavity 22 into a first acoustic cavity 22-1 and a second acoustic cavity 22-2. The sound generating component refers to the part of the speaker 110 that generates vibrations, such as a diaphragm, vibrating beam, vibrating rod, vibrating block, etc. The first acoustic cavity 22-1 refers to the acoustic resonant cavity through which the first sound generated by the speaker 110 passes before entering the external free space. The second acoustic cavity 22-2 refers to the acoustic resonant cavity where the component of the first sound generated by the speaker 110 does not directly propagate into the external free space. In other words, the sound generating component of the speaker 110 divides the acoustic cavity 22 into two sub-cavities, with the sub-cavity facing the sound generating surface of the component being the first acoustic cavity 22-1, and the sub-cavity opposite the sound generating surface being the second acoustic cavity 22-2. The first acoustic cavity 22-1 can also be called the front cavity, and the second acoustic cavity 22-2 can also be called the rear cavity.

Based on the acoustic cavity design described above, in some exemplary embodiments, the second sound sensor 120-2 can be located inside the acoustic cavity 22, while the first sound sensor 120-1 can be located outside the acoustic cavity 22. It is understood that, since the speaker 110 is located inside the acoustic cavity 22, placing the second sound sensor 120-2 inside the acoustic cavity 22 and placing the first sound sensor 120-1 outside the acoustic cavity 22 allows the second sound sensor 120-2 to pick up a stronger sound from the speaker 110 relative to the first sound sensor 120-1. That is, the signal energy |x2|2 corresponding to the first sound in the second signal y2 is much greater than the signal energy |x1|2 corresponding to the first sound in the first signal y1, thereby helping the first signal y1 and the second signal y2 to satisfy the condition k2≥2k1.

The second sound sensor 120-2 can be positioned in various ways within the acoustic cavity 22. For example, referring to FIG. 8A, the second sound sensor 120-2 can be placed inside the first acoustic cavity 22-1. In this case, the second sound sensor 120-2 is able to capture a stronger version of the first sound compared to the first sound sensor 120-1, which helps to achieve the following condition: the signal energy |x2|2 corresponding to the first sound in the second signal y2 is much greater than the signal energy |x1|2 corresponding to the first sound in the first signal y1, which helps to make the first signal y1 and the second signal y2 satisfy the condition k2≥2k1.

In another example, referring to FIG. 8B, the second sound sensor 120-2 can be located inside the second acoustic cavity 22-2. This method can achieve the following two effects: first, the second sound sensor 120-2 can capture a stronger first sound at least in a partial frequency band compared to the first sound sensor 120-1, thereby helping to achieve the following conditions: the signal energy |x2|2 corresponding to the first sound in the second signal y2 is much greater than the signal energy |x1|2 corresponding to the first sound in the first signal y1. On the second hand, the speaker 110 will have a certain blocking effect on the second sound emitted by the target sound source 160, thereby helping to achieve the following conditions: the signal energy |v2|2 corresponding to the second sound in the second signal y2 is much less than the signal energy |v1|2 corresponding to the second sound in the first signal y1. The combined effect of the above two aspects enables the condition k2≥2k1 to be achieved.

Also, for example, refer to FIG. 8C, the second sound sensor 120-2 can be coupled with the sound generating component of the speaker 110. For instance, the second sound sensor 120-2 can be a lighter-weight bone conduction MIC, and the speaker 110 can be an air-conduction speaker. The bone conduction MIC can be fitted (attached) to the diaphragm of the air-conduction speaker. In this way, since the bone conduction MIC picks up bone vibration signals, air vibrations will not interfere with the bone conduction MIC's sound pickup, thereby ensuring the accuracy of the second signal y2 picked up by the bone conduction MIC. Additionally, the acoustic system 20, by using a lighter-weight bone conduction MIC, can reduce the impact of the bone conduction MIC on the diaphragm vibration of the speaker, thus avoiding introducing additional distortion. It should be noted that this coupling method is applicable to various types of sound sensors and speakers, and the coupling method of the above bone conduction MIC and air-conduction speaker is just one possible example.

In the acoustic system shown in FIG. 8C, since the second sound sensor 120-2 is coupled with the sound generating component of the speaker 110, the second sound sensor 120-2 is able to directly capture the sound emitted by the speaker 110. Therefore, compared with the first sound sensor 120-1, the second sound sensor 120-2 is able to capture a stronger first sound. Therefore, the signal energy |x2|2 corresponding to the first sound in the second signal y2 is much greater than the signal energy |x1|2 corresponding to the first sound in the first signal y1, which helps the first signal y1 and the second signal y2 satisfy the condition k2≥2k1.

It should be noted that the design of FIGS. 8A to 8C does not specify the exact location of the first sound sensor 120-1, as long as it is located outside the acoustic cavity 22 and can conveniently pick up the sound from the target sound source 160. For example, the first sound sensor 120-1 can be located inside the housing 21, with the sound pickup surface positioned on the surface of the housing 21 away from the acoustic cavity 22. FIGS. 8A to 8C do not provide an illustration of the position of the first sound sensor 120-1.

In some exemplary embodiments, the sound pickup surface of the first sound sensor 120-1 and the sound pickup surface of the second sound sensor 120-2 can both be located in the free space outside the housing 21, and the second sound sensor 120-2 is positioned closer to the speaker 110 (or closer to the acoustic cavity 22) relative to the first sound sensor 120-1. The free space here refers to a space where sound is not affected by reflection, refraction, or diffraction, and propagates mainly in the form of spherical waves or plane waves. For example, refer to FIG. 8E, where the second sound sensor 120-2 can be set in the free space outside the housing 21, without being physically connected to the housing 21. In this case, the second sound sensor 120-2 can be a wired or wireless MIC. After the second signal y2 is captured in the free space, it can be transmitted to the signal processing circuit 150 via a wired or wireless connection.

In some exemplary embodiments, referring to FIG. 8D, part of the housing 21 of the acoustic system can form acoustic cavities 22 and 23. In this case, the speaker 110 is located inside the acoustic cavity 22, the second sound sensor 120-2 is located inside the acoustic cavity 23, and the second sound sensor 120-2 is positioned closer to the speaker 110 compared to the first sound sensor 120-1. The acoustic cavity 23 can serve as a windproof enclosure for the second sound sensor 120-2, which can also be referred to as a windproof cavity. The second sound sensor 120-2 inside the acoustic cavity 23 can still pick up sound signals from the free space.

It should be noted that the design of FIGS. 8D to 8E does not specify the exact location of the first sound sensor 120-1, as long as the sound pickup surface of the first sound sensor 120-1 is located in the free space and can conveniently pick up sound from the target sound source 160 in the free space. For example, the first sound sensor 120-1 can be located inside the housing 21, with the sound pickup surface positioned on the surface of the housing 21 away from the acoustic cavity 22. FIGS. 8D and 8E do not provide an illustration of the position of the first sound sensor 120-1.

In the designs shown in FIGS. 8D and 8E, since the second sound sensor 120-2 is positioned closer to the speaker 110 compared to the first sound sensor 120-1, the second sound sensor 120-2 is able to capture a stronger first sound relative to the first sound sensor 120-1. As a result, the signal energy |x2|2 corresponding to the first sound in the second signal y2 is much greater than the signal energy |x1|2 corresponding to the first sound in the first signal y1, which helps ensure that the first signal y1 and the second signal y2 satisfy the condition k2≥2k1. Additionally, in the design shown in FIG. 8E, since the second sound sensor 120-2 is located in the free space outside the housing 21, there is no need to modify the housing 21 structure or the acoustic cavity 22, making it easier to implement. In the design shown in FIG. 8D, since the second sound sensor 120-2 is located in a different acoustic cavity outside the acoustic cavity 22, there is no need to modify the acoustic cavity 22, making it easier to implement as well.

In some exemplary embodiments, the sound pickup surface of the first sound sensor 120-1 can be positioned in the free space outside the housing 21, while the sound pickup surface of the second sound sensor 120-2 can be positioned in the internal space of the housing 21. Moreover, the second sound sensor 120-2 is closer to the speaker 110 (or closer to the acoustic cavity 22) than the first sound sensor 120-1. For example, referring to FIG. 8F, the second sound sensor 120-2 can be positioned inside the housing 21 near the second acoustic cavity 22-2 (or the rear cavity), and the sound pickup surface of the second sound sensor 120-2 faces the second acoustic cavity 22-2. It should be noted that this disclosure does not limit the specific location of the first sound sensor 120-1, as long as it can conveniently pick up sound from the target sound source 160. For example, the first sound sensor 120-1 can be located inside the housing 21, with the sound pickup surface positioned on the surface of the housing 21 away from the speaker 110 (or away from the acoustic cavity 22). The position of the first sound sensor 120-1 is not illustrated in FIG. 8F.

In the design shown in FIG. 8F, since the second sound sensor 120-2 is close to the rear cavity (i.e., the second acoustic cavity 22-2), the second sound sensor 120-2 can pick up the first sound leaking from the rear cavity or the first sound propagating through the solid medium. Furthermore, since the second sound sensor 120-2 is positioned closer to the speaker 110 compared to the first sound sensor 120-1, the second sound sensor 120-2 is able to capture a stronger first sound relative to the first sound sensor 120-1. As a result, the signal energy |x2|2 corresponding to the first sound in the second signal y2 is much greater than the signal energy |x1|2 corresponding to the first sound in the first signal y1. Additionally, since the first sound sensor 120-1 is hidden inside the housing 21, the housing 21 provides some blockage to the sound from the target sound source 160. As a result, the signal energy |v2|2 corresponding to the second sound in the second signal y2 is much smaller than the signal energy |v1|2 corresponding to the second sound in the first signal y1. These two factors together help ensure that the first signal y1 and the second signal y2 satisfy the condition k2≥2k1. Furthermore, the above solution does not require modifications to the acoustic cavity 22, making it easier to implement.

In some exemplary embodiments, the first sound sensor 120-1 and the speaker 110 can also be coupled to different housings. For example, the acoustic system 20 can further include a first housing and a second housing. The first housing can be considered the outer shell of the acoustic system 20. The first sound sensor 120-1 can be located inside the first housing, with the sound pickup surface positioned on the surface of the first housing and facing the free space outside the first housing. The second housing can also be located inside the first housing, and the second housing forms an acoustic cavity where the speaker 110 and the second sound sensor 120-2 are located inside the acoustic cavity. Similar to FIGS. 8A to 8C, the sound generating component of the speaker 110 can divide the acoustic cavity into a first acoustic cavity (front cavity) and a second acoustic cavity (rear cavity). The second sound sensor 120-2 can be located inside the first acoustic cavity, inside the second acoustic cavity, or coupled with the sound generating component of the speaker 110.

Based on the above design, the first sound sensor 120-1 picks up sound in the free space outside the first housing, while the second sound sensor 120-2 picks up sound inside the acoustic cavity within the first housing. Due to the blocking effect of the first housing on sound, on one hand, it reduces the second sound sensor 120-2′s ability to pick up sound from the target sound source 160, and on the other hand, it reduces the first sound sensor 120-1′s ability to pick up sound from the speaker 110. As a result, the signal energy |x2|2 corresponding to the first sound in the second signal y2 is much greater than the signal energy |x1|2 corresponding to the first sound in the first signal y1, and the signal energy |v2|2 corresponding to the second sound in the second signal y2 is much smaller than the signal energy |v1|2 corresponding to the second sound in the first signal y1. This further helps ensure that the first signal y1 and the second signal y2 satisfy the condition k2≥2k1.

In some exemplary embodiments, the acoustic system 20 can also include a baffle. The baffle serves to block sound. It should be noted that the present application does not limit the form of the baffle; it can be a blocking panel, a blocking cover, or other similar structures. The second sound sensor 120-2 and the speaker 110 are located on the first side of the baffle, while the first sound sensor 120-1 is located on the second side of the baffle. As a result, since the baffle blocks the first sound, the first sound sensor 120-1 picks up less of the first sound relative to the second sound sensor 120-2. In other words, the second sound sensor 120-2 is able to capture a stronger first sound compared to the first sound sensor 120-1. As a result, the signal energy |x2|2 corresponding to the first sound in the second signal y2 is much greater than the signal energy |x1|2 corresponding to the first sound in the first signal y1, which helps ensure that the first signal y1 and the second signal y2 satisfy the condition k2≥2k1.

Scheme 2: The acoustic system 20 can be designed from the perspective of sound pickup directionality, such that the pickup directionality of the first sound sensor 120-1 and the second sound sensor 120-2 meets preset conditions, thereby ensuring that the first signal y1 and the second signal y2 satisfy the condition k2≥2k1.

The sound pickup directionality of a sound sensor refers to the different degrees of directionality in different directions due to the sensor's varying sound pickup sensitivity. The sound pickup sensitivity in a particular direction refers to the sensor's ability to pick up sound coming from that direction. When the sound pickup sensitivity in a given direction is higher, it means the sensor has a stronger ability to pick up sound from that direction, and the signal components corresponding to the sound from that direction in the captured audio signal are greater, thus the sensor's directionality towards that direction is stronger. When the sound pickup sensitivity in a given direction is lower, it means the sensor has a weaker ability to pick up sound from that direction, and the signal components corresponding to the sound from that direction in the captured audio signal are smaller, thus the sensor's directionality towards that direction is weaker. When the sound pickup sensitivity in a given direction is zero, it means the sensor does not pick up sound from that direction, and that direction can be referred to as the zero-point pickup direction.

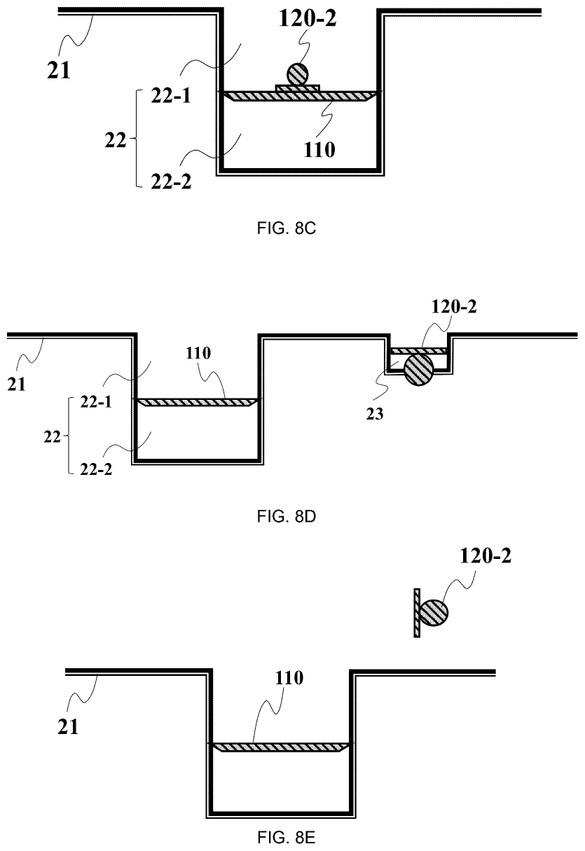

FIG. 9 shows a schematic of the sound pickup directionality of the acoustic system provided in the embodiments of this disclosure. As shown in FIG. 9, the sound pickup directionality of the first sound sensor 120-1 and the second sound sensor 120-2 can satisfy at least one of the following conditions:

(1) The sound pickup sensitivity of the first sound sensor 120-1 in the first direction is greater than its sound pickup sensitivity in the second direction.

In this case, the first direction points towards the target sound source 160, and the second direction points towards the speaker 110. It can be understood that when the above condition (1) is met, the first sound sensor 120-1 can primarily pick up the sound from the target sound source 160. To design the acoustic system 20 in order to satisfy the above condition (1), the direction of the first sound sensor 120-1 with a higher sound pickup sensitivity can be pointed towards the target sound source 160, and/or the direction of the first sound sensor 120-1 with a lower sound pickup sensitivity can be pointed towards the speaker 110. For example, the direction with the highest sound pickup sensitivity of the first sound sensor 120-1 can be pointed towards the target sound source 160, and/or the direction with the lowest sound pickup sensitivity of the first sound sensor 120-1 can be pointed towards the speaker 110.

(2) The sound pickup sensitivity of the second sound sensor 120-2 in the first direction is less than its sound pickup sensitivity in the second direction.

When the above condition (2) is satisfied, the second sound sensor 120-2 can primarily pick up the sound from the speaker 110. To design the acoustic system 20 in order to satisfy the above condition (2), the direction of the second sound sensor 120-2 with a higher sound pickup sensitivity can be pointed towards the speaker 110, and/or the direction of the second sound sensor 120-2 with a lower sound pickup sensitivity can be pointed towards the target sound source 160. For example, the direction with the highest sound pickup sensitivity of the second sound sensor 120-2 can be pointed towards the speaker 110, and/or the direction with the lowest sound pickup sensitivity of the second sound sensor 120-2 can be pointed towards the target sound source 160.

It should be noted that only one of the above conditions (1) and (2) needs to be satisfied. When condition (1) is satisfied, the first sound sensor 120-1 primarily picks up sound from the target sound source 160. When condition (2) is satisfied, the second sound sensor 120-2 primarily picks up sound from the speaker 110. In both cases, it helps ensure that the first signal y1 and the second signal y2 satisfy the condition k2≥2k1. Furthermore, when both conditions (1) and (2) are satisfied simultaneously, the first sound sensor 120-1 can pick up a stronger sound from the target sound source 160 relative to the second sound sensor 120-2, and the second sound sensor 120-2 can pick up a stronger sound from the speaker 110 relative to the first sound sensor 120-1. As a result, the signal energy corresponding to the first sound in the second signal y2, |x2|2, is much greater than the signal energy corresponding to the first sound in the first signal y1, |x1|2, and the signal energy corresponding to the second sound in the second signal y2, |v2|2, is much smaller than the signal energy corresponding to the second sound in the first signal y1, |v1|2, which further helps ensure that the first signal y1 and the second signal y2 satisfy the condition k2≥2k1.

It should be noted that the sound pickup directivity of the first sound sensor 120-1 and the sound pickup directivity of the second sound sensor 120-2 can both be achieved by using a single pickup device with a certain directivity, or they can be achieved by using multiple pickup devices to form a preset array. This disclosure does not impose any limitations on this. Additionally, this disclosure does not specifically limit the pickup direction patterns corresponding to the first sound sensor 120-1 and the second sound sensor 120-2. They can use the same pickup direction pattern or different pickup direction patterns. For example, the pickup direction patterns of the first sound sensor 120-1 and the second sound sensor 120-2 can both be omnidirectional patterns, heart-shaped patterns, super-heart-shaped patterns, 8-shaped patterns, gun-shaped patterns, or any other directional patterns. For instance, in FIG. 9, the pickup direction pattern of the first sound sensor 120-1 is gun-shaped, and its stronger pickup direction points towards the target sound source 160, while the pickup direction pattern of the second sound sensor 120-2 is heart-shaped, and its stronger pickup direction points towards the speaker 110.

Since scheme 2 is designed from the perspective of sound pickup directivity, it is necessary to design the sound pickup directivity of the first sound sensor 120-1 and/or the second sound sensor 120-2, and the positional relationship of the devices in the acoustic system can either be left unconstrained or have relaxed requirements. Therefore, scheme 2 is applicable in scenarios where it is inconvenient to make structural changes to the acoustic system 20. In some exemplary embodiments, scheme 2 can also be combined with one or more designs from the previous scheme 1.

Scheme 3: The positions of the first sound sensor 120-1 and the second sound sensor 120-2 can be designed based on the feedback sound energy at each position in the target area, so that the first signal y1 and the second signal y2 satisfy the condition k2≥2k1.

For example, the first sound sensor 120-1 is located at a first position in the target area, and the second sound sensor 120-2 is located at a second position in the target area, where the first position and the second position satisfy at least one of the following conditions:

(1) The sound energy from the speaker 110 at the first position is less than the sound energy from the speaker 110 at other positions in the target area, excluding the first position.

In other words, the first sound sensor 120-1 is placed at the position in the target area where the feedback sound energy (i.e., the sound energy from the speaker 110) is the smallest. When condition (1) is met, the first sound sensor 120-1 either picks up no or a weaker sound from the speaker 110.

(2) The sound energy from the speaker 110 at the second position is greater than the sound energy from the speaker 110 at other positions in the target area, excluding the second position.

In other words, the second sound sensor 120-2 is placed at the position in the target area where the feedback sound energy (i.e., the sound energy from the speaker 110) is the largest. When condition (2) is met, the second sound sensor 120-2 can pick up a stronger sound from the speaker 110.

It should be noted that only one of the above conditions (1) and (2) needs to be satisfied. When any one of them is satisfied, it is helpful for the first signal y1 and the second signal y2 to satisfy the condition k2≥2k1. Further, when the above conditions (1) and (2) are satisfied at the same time, the first sound sensor 120-1 cannot pick up or picks up the weaker sound of the speaker 110, and the second sound sensor 120-2 can pick up the stronger sound of the speaker 110. Thus, the signal energy |x2|2 corresponding to the first sound in the second signal y2 is much greater than the signal energy |x1|2 corresponding to the first sound in the first signal y1, which is more helpful for the first signal y1 and the second signal y2 to satisfy the condition k2≥2k1.

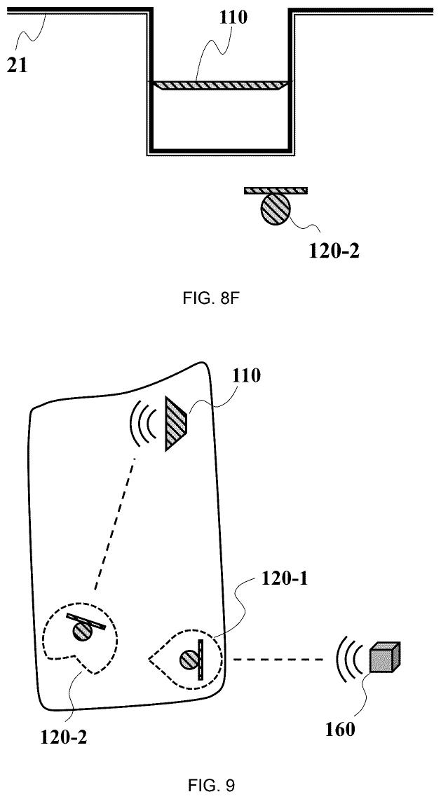

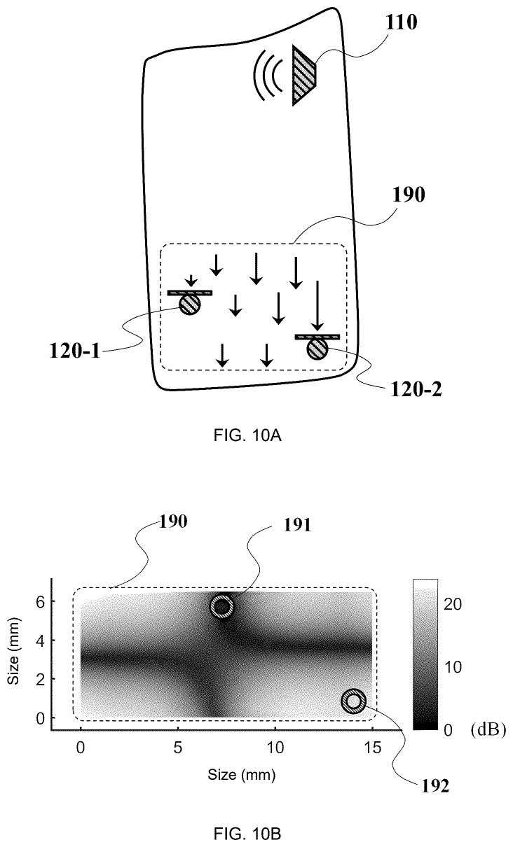

FIG. 10A illustrates the positions of the first and second sound sensors in the target area within the acoustic system according to an embodiment provided in this disclosure. As shown in FIG. 10A, different locations within the target area 190 are marked with arrows, where the length of the arrow represents the amount of feedback sound energy (i.e., the sound energy from the speaker 110) at that location. The longer the arrow, the greater the feedback sound energy; the shorter the arrow, the smaller the feedback sound energy. Continuing with FIG. 10A, within the target area 190, the location of the first sound sensor 120-1 corresponds to the minimum feedback sound energy, while the location of the second sound sensor 120-2 corresponds to the maximum feedback sound energy.

In order to satisfy the above conditions (1) and (2), the following method can be used to design the acoustic system 20: First, determine the target area 190 within the device of the acoustic system 20 where the first sound sensor 120-1 and the second sound sensor 120-2 will be placed. Then, through simulation calculations or field measurements, obtain the distribution of feedback sound energy at each position within the target area 190. For example, FIG. 10B shows a schematic diagram of the feedback sound energy at each position in the target area of the acoustic system. In this diagram, the higher the gray value at a given position in the target area 190 (with a gray value of 0 being black and 255 being white), the greater the feedback sound energy at that position. Conversely, the lower the gray value, the weaker the corresponding feedback sound energy. Consequently, the position in the target area 190 corresponding to the strongest feedback sound energy is selected as the second position 192, and the second sound sensor 120-2 is placed at this second position 192; the position in the target area 190 corresponding to the weakest feedback sound energy is selected as the first position 191, and the first sound sensor 120-1 is placed at this first position 191.

It should be noted that this disclosure does not impose any specific limitations on the shape of the target area 190. In FIGS. 10A and 10B, a rectangular shape is used for illustration. In practical applications, the target area 190 can have any other shape, such as circular, triangular, pentagonal, hexagonal, annular, hollowed-out, and other irregular shapes, or even a three-dimensional space-enclosed region.

Since Scheme 3 is based on the feedback sound energy at each position in the target area 190 to design the positions of the first sound sensor 120-1 and the second sound sensor 120-2, that is, placing the first sound sensor 120-1 at the position with the minimal feedback sound energy in the target area 190 and placing the second sound sensor 120-2 at the position with the maximum feedback sound energy-Scheme 3 does not impose strict requirements on the relative positions of the devices in the acoustic system 20 (for example, it does not require that the first sound sensor 120-1 be far from the speaker 110 or that the second sound sensor 120-2 be close to the speaker 110). Scheme 3 can be applied to scenarios where the positions of components are not pre-determined and where the locations of components are chosen within a certain candidate area. In some exemplary embodiments, Scheme 3 can also be combined with one or more of the designs from Scheme 1 and Scheme 2.

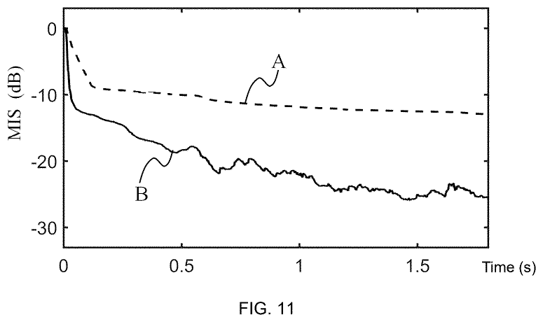

FIG. 11 shows the test results of the adaptive filtering performance of the acoustic system according to the embodiments provided in this disclosure. Referring to FIG. 11, in the acoustic system 20 where the speaker 110 has limited amplitude characteristics, when the adaptive filtering scheme based on AFC shown in FIG. 2 is used, the calculated distortion (MIS) is shown by curve A. When the adaptive filtering scheme based on AFC shown in FIG. 4 is used, the calculated distortion (MIS) is shown by curve B. In FIG. 11, curve B decreases faster than curve A in the initial phase (before approximately 0.2 seconds), and continues to maintain a faster average decreasing trend after the turning point (after approximately 0.2 seconds). That is, curve B stays below curve A throughout the entire shown time period. Therefore, the distortion MIS of the scheme shown in FIG. 4 is always lower than that of the scheme in FIG. 2, meaning that the scheme in FIG. 4 performs better in terms of the convergence degree and convergence speed of the adaptive filtering algorithm. As seen from FIG. 11, the scheme shown in FIG. 4 exhibits a significant improvement in both the convergence degree and convergence speed of the adaptive filtering algorithm.

In summary, the acoustic system 20 provided by this disclosure includes: a speaker 110, a first sound sensor 120-1, a second sound sensor 120-2, and a signal processing circuit 150. When the speaker 110 is working, it receives a driving signal and converts it into the first sound; the first sound sensor 120-1, when working, collects ambient sound and generates the first signal, where the ambient sound includes the first sound and the second sound from a target sound source; the second sound sensor 120-2, when working, collects ambient sound and generates the second signal, where the first signal and the second signal satisfy k2≥2k1, where k1 is the ratio of the signal energy corresponding to the first sound to the signal energy corresponding to the second sound in the first signal, and k2 is the ratio of the signal energy corresponding to the first sound to the signal energy corresponding to the second sound in the second signal. The signal processing circuit 150 is connected to both the first sound sensor 120-1 and the second sound sensor 120-2, and, when working, reduces the signal component corresponding to the first sound in the first signal based on the second signal, obtaining the target signal, and performs target operations on the target signal. Thus, the acoustic system 20 provided by this disclosure can reduce or eliminate the feedback components in the target signal, thereby avoiding problems such as squealing caused by feedback sound, and also enhancing the maximum forward gain that the acoustic system 20 can achieve.

The above description pertains to specific embodiments of the present disclosure. Other embodiments are within the scope of the appended claims. In some cases, the actions or steps described in the claims can be performed in a sequence different from the one in the embodiments and still achieve the desired result. Additionally, the processes depicted in the drawings do not necessarily require a specific order or continuous sequence to achieve the desired outcome. In certain embodiments, multitasking and parallel processing are also possible or may be beneficial.

In summary, after reading this detailed disclosure, those skilled in the art can understand that the aforementioned detailed disclosure is presented only by way of example and is not intended to be limiting. Although not explicitly stated here, those skilled in the art will appreciate that the disclosure encompasses various reasonable alterations, improvements, and modifications to the embodiments. These alterations, improvements, and modifications are intended to be within the spirit and scope of the exemplary embodiments presented in this disclosure.

In addition, certain terms in this disclosure have been used to describe the embodiments of the disclosure. For example, the terms “one embodiment,” “embodiment,” and/or “some exemplary embodiments” mean that specific features, structures, or characteristics described in connection with that embodiment may be included in at least one embodiment of the disclosure. Therefore, it should be emphasized and understood that references to “embodiment,” “one embodiment,” or “alternative embodiment” in various parts of this disclosure do not necessarily refer to the same embodiment. Additionally, specific features, structures, or characteristics may be appropriately combined in one or more embodiments of the disclosure.

It should be understood that in the foregoing description of the embodiments of the disclosure, in order to aid in understanding a feature and simplify the presentation, various features are combined in a single embodiment, drawing, or description. However, this does not mean that the combination of these features is required. A person skilled in the art, upon reading this disclosure, could very well consider part of the equipment marked as a separate embodiment. In other words, the embodiments in this disclosure can also be understood as the integration of multiple sub-embodiments. And each sub-embodiment is valid even when it includes fewer features than a single full embodiment disclosed above.

Each patent, patent application, publication of a patent application, and other materials, such as articles, books, disclosures, publications, documents, articles, etc., cited herein, except for any historical prosecution documents to which it relates, which may be inconsistent with or any identities that conflict, or any identities that may have a restrictive effect on the broadest scope of the claims, are hereby incorporated by reference for all purposes now or hereafter associated with this document. Furthermore, in the event of any inconsistency or conflict between the description, definition, and/or use of a term associated with any contained material, the term used in this document shall prevail.

Finally, it should be understood that the embodiments of the application disclosed herein are illustrative of the principles of the embodiments of this disclosure. Other modified embodiments are also within the scope of this disclosure. Therefore, the embodiments disclosed in this disclosure are merely examples and not limitations. Those skilled in the art can adopt alternative configurations based on the embodiments in this disclosure to implement the application in this disclosure. Thus, the embodiments of this disclosure are not limited to the embodiments described in the application in precise detail.

What is claimed is:

1. An acoustic system, comprising:
a speaker, configured to receive a drive signal and convert the drive signal into a first sound when operating;
a first sound sensor, configured to collect ambient sound and generate a first signal when operating, wherein the ambient sound comprises the first sound and a second sound from a target sound source, the target sound source comprises a sound source other than the speaker;
a second sound sensor, configured to collect the ambient sound and generate a second signal when operating, wherein the first signal and the second signal satisfy k₂≥2k₁, wherein k₁ is a ratio of a signal energy corresponding to the first sound to a signal energy corresponding to the second sound in the first signal, and k₂ is a ratio of a signal energy corresponding to the first sound to a signal energy corresponding to the second sound in the second signal; and
a signal processing circuit, connected to the first sound sensor and the second sound sensor, and configured to:
reduce a signal components in the first signal corresponding to the first sound based on the second signal to obtain a target signal, and perform a target operation on the target signal.

2. The acoustic system according to claim 1, wherein, to satisfy k₂≥2k₁, the first signal and the second signal satisfy at least one of the following conditions:
a ratio of the signal energy corresponding to the first sound in the second signal to the signal energy corresponding to the second sound in the second signal is greater than or equal to 2;
a ratio of the signal energy corresponding to the first sound in the second signal to the signal energy corresponding to the first sound in the first signal is greater than or equal to 2; or
a ratio of the signal energy corresponding to the second sound in the first signal to the signal energy corresponding to the first sound in the first signal is greater than or equal to 2.

3. The acoustic system according to claim 1, wherein a positional relationship of the first sound sensor, the second sound sensor and the speaker meets a preset condition, so that the first signal and the second signal satisfy k₂≥2k₁.

4. The acoustic system according to claim 3, wherein the preset condition comprises: L₁≥2L₂, wherein L₂ is a distance between the second sound sensor and the speaker, and L₁ is a distance between the first sound sensor and the speaker.

5. The acoustic system according to claim 3, wherein the acoustic system further comprises a housing, a part of the housing forms an acoustic cavity, the speaker and the second sound sensor are both located inside the acoustic cavity, and the first sound sensor is located outside the acoustic cavity.

6. The acoustic system according to claim 5, wherein a sound generating component of the speaker divides the acoustic cavity into a first acoustic cavity and a second acoustic cavity, and a sound generating surface of the sound generating component faces the first acoustic cavity, wherein
the second sound sensor is located inside the first acoustic cavity, or
the second sound sensor is located inside the second acoustic cavity.

7. The acoustic system according to claim 5, wherein the second sound sensor is coupled to the sound generating component of the speaker.

8. The acoustic system according to claim 3, wherein the acoustic system further comprises a housing, a sound pickup surface of the second sound sensor and a sound pickup surface of the first sound sensor are both located in a free space outside the housing, and the second sound sensor is closer to the speaker than the first sound sensor.

9. The acoustic system according to claim 3, wherein the acoustic system further comprises a housing, a first acoustic cavity and a second acoustic cavity are formed in a partial area of the housing, the speaker is located in the first acoustic cavity, the second sound sensor is located in the second acoustic cavity, and the second sound sensor is closer to the speaker than the first sound sensor.

10. The acoustic system according to claim 3, wherein the acoustic system further comprises a housing, a sound pickup surface of the first sound sensor is located in a free space outside the housing, a sound pickup surface of the second sound sensor is located in an internal space of the housing, and the second sound sensor is closer to the speaker than the first sound sensor.

11. The acoustic system according to claim 3, wherein the acoustic system further comprises a first housing and a second housing, wherein
the second housing is located inside the first housing, the second housing forms an acoustic cavity, and the speaker and the second sound sensor are located inside the acoustic cavity.

12. The acoustic system according to claim 3, wherein the acoustic system further comprises a baffle, the second acoustic sensor and the speaker are located on a first side of the baffle, and the first acoustic sensor is located on a second side of the baffle.

13. The acoustic system according to claim 1, wherein sound pickup directivities of the first sound sensor and the second sound sensor meet a preset condition, so that the first signal and the second signal satisfy k₂≥2k₁.

14. The acoustic system according to claim 13, wherein the sound pickup directivities of the first sound sensor and the second sound sensor satisfy at least one of the following conditions:
a sound pickup sensitivity of the first sound sensor in a first direction is greater than a sound pickup sensitivity of the first sound sensor in a second direction; or
a sound pickup sensitivity of the second sound sensor in the first direction is less than a sound pickup sensitivity in the second direction, wherein
the first direction points to the target sound source, and the second direction points to the speaker.

15. The acoustic system according to claim 1, wherein the first sound sensor is located at a first position within a target area, and the second sound sensor is located at a second position within the target area, wherein the first position and the second position satisfy at least one of the following conditions:
a sound energy from the speaker at the first position is less than a sound energy from the speaker at another position in the target area except the first position; or
a sound energy from the speaker at the second position is greater than a sound energy from the speaker at another position in the target area except the second position.

16. The acoustic system according to claim 1, wherein to obtain the target signal, the signal processing circuit is configured to:
perform an adaptive filtering operation on the second signal to obtain a third signal, and subtracts the third signal from the first signal to obtain the target signal.

17. The acoustic system according to claim 16, wherein the signal processing circuit is further configured to:
update filtering parameters corresponding to the adaptive filtering operation based on at least one of the second signal or the target signal.

18. The acoustic system according to claim 1, wherein to obtain the target signal, the signal processing circuit is configured to:
perform a first preprocessing operation on the first signal to obtain a first intermediate signal;
perform a second preprocessing operation on the second signal to obtain a second intermediate signal; and
reducing a signal component corresponding to the first sound in the first intermediate signal based on the second intermediate signal to obtain the target signal.

19. The acoustic system according to claim 18, wherein the first preprocessing operation comprises at least one of a gain amplification operation, a filtering operation, a frequency response compensation operation, or a phase modification operation; and
the second preprocessing operation comprises at least one of a gain amplification operation, a filtering operation, a frequency response compensation operation, or a phase modification operation.

20. The acoustic system according to claim 1, wherein the signal processing circuit is further connected to the speaker, and when performing the target operation, the signal processing circuit:
amplifies the target signal, and
sends an amplified signal to the speaker to drive the speaker to produce a sound.
